(19) United States
(12) Patent Application Publication
(10) Pub. No.: US 2011/0248495 A1
(43) Pub. Date: Oct. 13, 2011

(54) CONNECTOR AND METHOD OF MAKING A CONNECTION

(76) Inventors: Tony LaPlante, Aberdeen (GB); Peter Murdoch, Aberdeen (GB); Richard Gilchrist, Aberdeen (GB)

(21) Appl. No.: 12/756,160

(22) Filed: Apr. 7, 2010

(51) Int. Cl. F16L 25/00

(52) U.S. Cl. 285/331

(57) ABSTRACT

A connector (1) for connecting to a tubular member has a body (5, 35, 65) with a bore (7, 37, 67) configured to receive the tubular member, the body having a wedge device (10, 40, 70) within the bore adapted to interact with the body to grip the tubular member (15) when the tubular member is disposed within the bore, wherein the wedge device is at least partially helical, and wherein the connector has an anti-rotation device (23, 53, 83) to restrict relative rotation of the wedge device and the body when the tubular is gripped in the bore.

### TECHNICAL FIELD

The present invention relates to a connector, suitable for use with a tubular member such as coiled tubing, and to a method of connecting the connector to a tubular member. Although the invention is described primarily with reference to coiled tubing, other types of tubular member (typically blank ended tubulars) can be used with the connector.

### BACKGROUND

Coiled tubing is used to deploy tools and other items in oil and gas wells. The coiled tubing is a long length of tubing, which is coiled on a reel, and is uncoiled from the reel as it is inserted into the wellbore. The tool or other item to be deployed in the wellbore on the coiled tubing is usually attached to the terminal end of the coiled tubing that is first inserted into the well. Coiled tubing connectors are used for connecting the terminal end of coiled tubing to the tool or other item.

### SUMMARY

According to the present invention there is provided a connector for connecting to a tubular member, the connector having a body with a bore configured to receive the tubular member, the body having a wedge device within the bore adapted to interact with the body to grip the tubular member when the tubular member is disposed within the bore, wherein the wedge device is at least partially helical, and wherein the connector has an anti-rotation device to restrict relative rotation of the wedge device and the body when the tubular is gripped in the bore.

Optionally the anti-rotation device can act direct on the wedge device, and typically act on the wedge device once it is in a compressed or energised configuration.

In some embodiments, the anti-rotation device can act direct on the tubular to restrict or prevent rotation of the tubular and the wedge device once the wedge device is energise by the movement of the tubular.

The wedge device can be in the form of a helix having more than one turn, or can be a single turn helix.

The wedge device can be any device that is tapered, typically on its outer surface, and which typically interacts with a matching tapered surface on the inner surface of the bore of the body, creating a wedging effect on the tubular to restrain it within the bore of the body, and typically acting to restrict or prevent axial movement of the tubular. The inner surface of the wedging device is typically configured to match and optionally to grip the outer surface of the tubular. The wedge device is designed to move within the bore with the tubular, and to exert a compressive force on the tubular within the bore to make up the connector.

The wedge device can interact with a seat in the body, which guides the movement of the wedge device in order to apply the compressive force against the tubular. The seat can also be in the form of a helix.

The seat can have tapered side walls acting to radially compress the wedge device against the tubular member when the tubular member moves axially in one direction within the bore, and to reduce radial compression on the tubular member when the tubular member moves axially within the bore in the other direction. In some embodiments, the seat can radially compress the wedge device when the wedge device and the seat rotate relative to one another in one direction, and can optionally reduce radial compression on the wedge device when the two are rotated relative to one another in the opposite direction.

According to the present invention there is provided a method of connecting a connector to a tubular member, the connector having a body with a bore configured to receive the tubular member, and having a partially helical wedge device within the bore, the method comprising gripping the tubular member within the bore, and locking the body and wedge device against rotation relative to one another when the tubular is gripped in the bore. In one embodiment, the wedge device is rotated relative to the body before being locked against relative rotation between the two.

In one embodiment the wedge device is pulled axially relative to the body before being locked against relative rotation between the two.

### BRIEF DESCRIPTION OF THE DRAWINGS

Embodiments of the present invention will now be described, by way of example, with reference to the accompanying drawings, in which:

FIG. 1 is a side view of a connector shown in partial section view;

FIG. 2 is a side sectional view of a body of the FIG. 1 connector

FIG. 3 is a side view of a wedge device used with connector of FIG. 1;

FIG. 4, FIG. 5 and FIG. 6 are side views of the FIG. 1 connector connected to a length of coiled tubing and showing sequential steps of making up the connector to the coiled tubing;

FIG. 7 shows a side view of a second connector in section;

FIG. 8 shows a side view of a third connector in section; and

FIG. 9 shows a plan view of a collar used in an anti-rotation device on the FIG. 8 connector.

### DETAILED DESCRIPTION

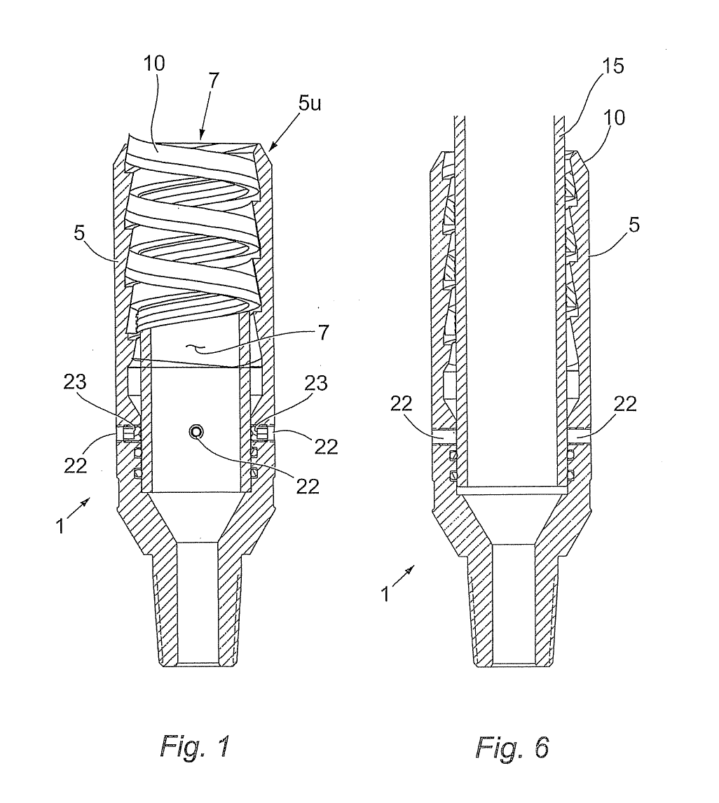

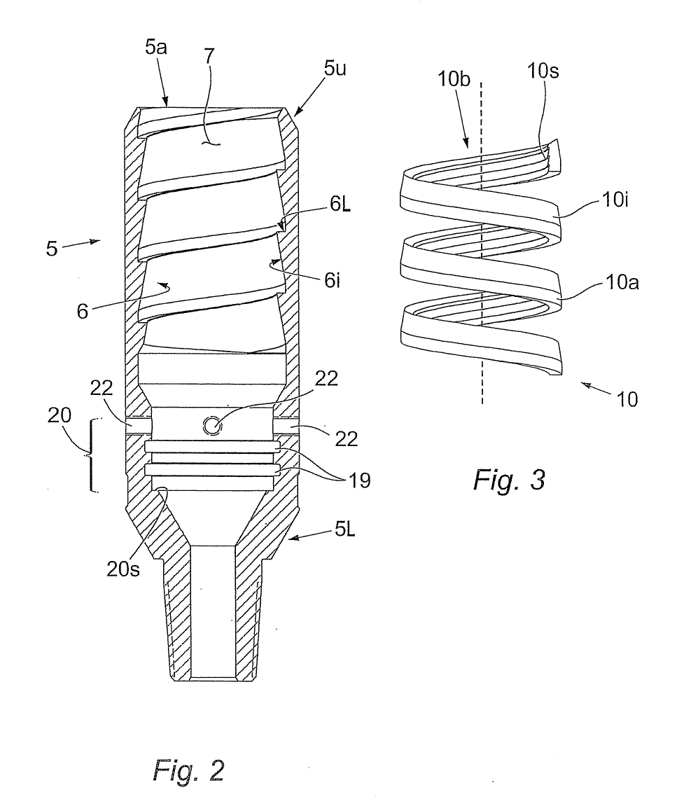

Referring now to the drawings, FIG. 1 shows a connector 1 comprising a body 5 having a bore 7 and a wedge device in the form of a wedge member 10 within the bore 7. At an upper end 5u of the body the bore 7 is coaxial with a wide aperture 5a adapted to receive one end of a length of coiled tubing 15, which can pass through the aperture 5a and which is received within the bore 7.

The wedge member 10 is typically in the form of a resilient steel strip that is coiled into an anticlockwise helix, as shown in FIG. 3. As shown in FIG. 1, the wedge member 10 is received with the bore 7, and engages a seat 6 formed on the inner surface of the upper end of the body 5 to cooperate with the wedge member 10 and compress it against the coiled tubing in use. The seat 6 in this embodiment has an anticlockwise helical profile that matches that of the wedge member 10, although the seat 6 need not be a complete helix, and can instead be formed from axially spaced shoulders within the bore 7, without being interconnected or in a continuous helical path.

Below the seat 6, at the lower end of the body 51, the bore 7 narrows to form a locking section 20 in the body 5, which has O-ring seals 18 located in annular recesses 19 to seal the coiled tubing 15 within the body 5. Below the locking section 20, a box or pin connector is provided for attachment to a tool (not shown) below the connector. The box or pin connector can be of any suitable design, and is typically chosen to cooperate with whichever component the tubing is to be made up to. The box or pin connector can optionally have a fluid channel to communicate with the bore 7, in order to allow fluid communication with the bore of the coiled tubing 15. In some embodiments, this will not be necessary. Typically the body 5 is formed as a single piece and the bore 7 is counter-bored from the apertured end. In certain embodiments, the body can be formed from a number of interconnected portions.

The locking section has a number of radial holes 22 drilled and tapped to receive threaded fixings such as bolts or screws 23. The bolts 23 are typically socket headed and are optionally threaded through the wall of the body 5 and can be driven against the coiled tubing 15 once in place in the bore 7 of the locking section 20.

Typically the wedge member 10 has three or more coils in the helix, but the number of coils in the wedge device can be varied. The helical wedge member 10 has a radially inner surface and a radially outer surface, and an axial bore 10b. In some embodiments the inner surface of the wedge member 10 that engages the outer surface of the coiled tubing 15 can be smooth, but the wedge member 10 can optionally grip the coiled tubing 15 more effectively if the inner surface has a profile like a wicker thread or a screw thread to increase the grip. The inner surface of the wedge member 10 can optionally be hardened. The radially inner surface therefore optionally has a wicker thread with radial projections, typically in the form of a helical thread 10s with saw-toothed cross sections, which extend the length of the wedge member 10. Typically three or four turns of thread 10s extend from the inner surface of each coil of the helical wedge member 10. In this example, the pitch of the thread 10s and the pitch of the helical wedge member 10 are the same, but this is not essential, and the pitch can be varied, and/or a finer or coarser thread can be provided in other embodiments.

The thread typically has an inclined face and a generally radial face. The inclined face is typically above the radial face i.e. closer to the aperture at the end of the bore 7. The radial face is aligned more closely with the radius of the wedge member 10 than the inclined face, which is more aligned with the long axis of the bore, but which inclines outwardly toward the top of the step. The generally radial face does not need to be precisely radial. The radial face and the inclined face meet at the radially innermost apex of each tooth. It will be appreciated that the particular angles of the two faces can be varied.

The thread engages the outer surface of the coiled tubing, and typically increases the grip of the wedge member 10 on the coiled tubing 15 held within the wedge member 10. In this example, the thread is not symmetrical, and allows the wedge member 10 to move up the coiled tubing more easily than it can move down the tubing. Therefore, the resistance to axial movement that is applied to the coiled tubing 15 by the wedge member 10 is greater in one direction (up, in the drawings) than in the other (down, in the drawings).

The outer surface of the wedge member 10 has an axial face 10a and a tapered face 10i. The axial face 10a is aligned with the axis of the bore 7. The tapered face 10i is arranged above the axial face 10a and is inclined slightly toward the top of the wedge device at an angle of around 5-20 degrees (e.g. 10-15 degrees) to the vertical.

The seat 6 has a profile that matches the outer surface of the wedge member 10. In particular, the seat 6 is in the form of a helix and describes a continuous helical path on the inner surface of the body 5, although in certain embodiments, the path could be non-continuous. In this embodiment, the seat has a continuous helical shoulder 61 extending radially into the bore 7 at approx 90 degrees to the axis of the bore 7, from the aperture at the top 5u of the body to the commencement of the narrowing at the locking section 20. The shoulder 61 is generally radial. The side faces 6i of the seat 6 are tapered or inclined between the adjacent coils of the ledge 61 to match the incline of the outer surface of the wedge member 10. This creates a wedge effect between the inner surface of the seat 6 and the outer surface of the wedge member 10. Therefore, movement of the helical wedge member 10 up the bore 7 causes radial compression of the wedge member 10 by virtue of the inclination of the faces 10i and 6i.

In use, the body 5 is equipped with O-rings on the surface, and the helical wedge member 10 is offered up to the aperture 5a at the end of the bore 7 and is threaded into the bore 7 from that end while being rotated, engaging and being guided down the bore 7 by the matching helical seat 6. The bore 7 of the body is co-axial with the bore 10b of the wedge member 10.

Once the wedge member 10 has been fully received within the helical seat 6, the connector is in the configuration shown in FIG. 1, and is ready to receive the coiled tubing 15. The end of the coiled tubing 15 is optionally cut square as normal, and is dressed and polished and is offered to the aperture 5a, and passes axially through the bore 10b of the wedge device, which is held stationary within the seat 6. Because of the asymmetry of the teeth on the inner surface of the wedge member 10, the coiled tubing 15 can pass easily down the bore 10b of the wedge member 10. The slight downward pressure of the coiled tubing 15 on the wedge member 10 urges the wedge member 10 further down the seat 6, allowing the resilient wedge member 10 to expand a little as the diameter of the seat increases with the inclined faces 6i, and this eases the passage of the coiled tubing 15 into the connector 1.

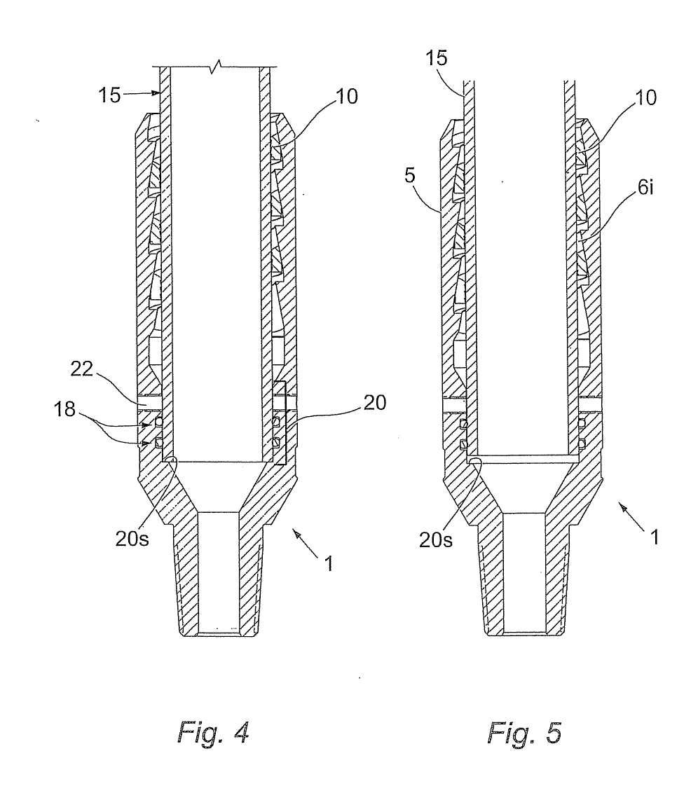

The lower end of the locking section 20 has an annular shoulder 20s that is narrower than the diameter of the coiled tubing 15. Once the coiled tubing 15 has bottomed out on the shoulder 20s, it can move no further into the bore 7, and is now in the position shown in FIG. 4. At this point, the coiled tubing 15 is gripped gently by the wedge member 10. In order to secure the grip of the wedge member 10 on the coiled tubing 15 and make up the connector 1, the connector 1 is then optionally rotated relative to the coiled tubing 15, which is held static, to energise the wedge member 10 and cause it to bite onto the outer surface of the tubing 15. Alternatively, the tubing can be pulled axially out of the bore 7 to energise the wedge member 10 (without being rotated). Some embodiments can combine rotation and axial pulling together.

The tubing 15 can then be pull-tested to further energise the wedge member 10, and to test the make up of the connector 1. This relative movement of the coiled tubing 15 and the wedge member 10 carries the wedge member axially with the coiled tubing up the bore toward the aperture 5a, because of the wicker thread profile that holds the wedge member 10 onto the outer surface of the coiled tubing.

The wedge member 10 therefore moves up the seat 6, and the interaction between the inclined faces 10i and 6i push the wedge member 10 inward and cause the wedge member 10 to bite into the outer surface of the coiled tubing, therefore locking the coiled tubing and the wedge member securely together, and leaving the connector and the coiled tubing 15 in the configuration shown in FIG. 5, with a slight gap between the end of the coiled tubing 15 and the shoulder 20s. The axial load is then removed, leaving the wedge member 10 and the tubing 15 tightly connected, the tubing is held stationary, and the connector is then rotated relative to the tubing 15 and the wedge member 10 to close the gap. The tubing 15 is then pulled axially again relative to the connector, and the cycle of axial pull and relative rotation continues until there is no more axial movement that results from the pull test, at which point the connector 1 and tubing 15 are in the configuration shown in FIG. 6.

Once the tubing 15 no longer moves from the position shown in FIG. 6 upon pull testing, the wedge member 10 is gripping the tubing with its maximum hold and the final make up step can be completed. At this stage, the bolts 23 are inserted into the holes 22 and driven against the coiled tubing to prevent its rotation relative to the connector 1. The axial load on the coiled tubing 15 is held not by the bolts 23, but by the wedge member 10. The length and/or pitch of the wedge member 10 can be increased in order to increase the surface area that is gripping and thereby to strengthen the hold applied by the connector 1. Provided that no rotational movement of the coiled tubing 15 is permitted relative to the connector, then axial load will be transmitted through the helical wedge member 10 and the seat 6, and not through the bolts 23. The bolts 23 merely need to restrict relative rotation between the tubing 15 and the connector 1.

In the present embodiment, the anti-rotation device(s) engage the tubing 15, which remains locked onto the wedge member 10 by means of the grip applied by the compression of the wedge member 10 within the bore 7. However, in certain other embodiments, the anti-rotation devices can engage the wedge device directly, and prevent its uncoiling within the bore, and do not need to engage the tubing direct.

Instead of the screw-threaded fixing, alternative designs of anti-rotation devices can be employed, such as pins, bars or circlips, configured to prevent or restrict uncoiling of the wedge device from its energised helical configuration. One advantage of this arrangement is that relatively weak pins can be provided spaced helically along the length of the helical portion of the wedge device in order to restrain its tendency to uncoil and lose its grip on the tubing.

Thus certain embodiments of the invention allow the attachment of tools to the bottom of a tubular member without the need to cut threads, crimp or deform the tubular in order to positively attach the tools. Also, certain embodiments can reduce the size and length limitations of existing designs of connector, and can facilitate making up the connectors onto coiled tubing with any residual bend. Some embodiments allow faster make up of the connector, and can reduce handling time and exposure to risks as a result, without sacrificing connection strength.

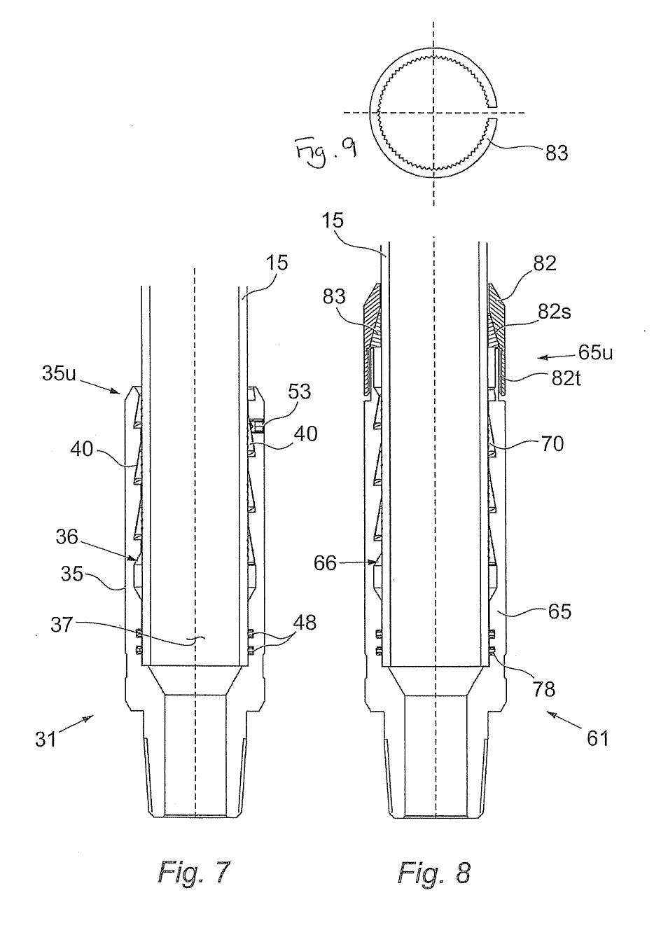

Referring now to FIG. 7, a second design of connector 31 is shown, which is similar to the connector 1, and similar components will be designated with the same reference numeral increased by 30. Therefore the connector 31 has a body 35 with a seat 36, a wedge member 40, and O-rings 48, adapted to hold tubing 15 as described above. The anti-rotation device of the connector 31 is disposed at the top end 35u of the body 35 of the connector 31, and comprises at least one socket headed bolt 53 located in a tapped hole 52 drilled through the body 35. The bolt 53 engages directly on the wedge member 40, and restricts its rotation or expansion in the seat 36, thereby keeping the wedge member 40 energised and engaged with the tubular and with the seat, thereby restricting rotation of the wedge member 40 in the bore 37. Additional bolts or other fixings can be provided to engage and restrict movement of the wedge member 40, optionally spaced helically or axially along the wedge member, and extending through the side wall of the body 35 in the same way as bolt 53. Optionally, additional bolts can be provided to engage the tubular 15, either at the base of the body 35 as described in the earlier embodiment, or at other locations along the tubular, in the same way, thereby locking everything together rotationally.

Note that the bolts do not need to withstand axial loads, and only need to restrict rotation. The bolts do not need to have a screw thread, and simple pins can be used instead, in some embodiments. Thus a simple pair of pins provided connecting the body and the wedge member at the upper and lower ends of the wedge member could suffice to restrict rotation of the wedge member. Note that this embodiment has anti-rotation devices that act directly on the wedge member, but it is possible to construct embodiments of the invention in which the anti-rotation device does not bear directly on the wedge member but restricts its rotation indirectly, via another component, such as the tubular.

Referring now to FIGS. 8 and 9, a third design of connector 61 is shown, which is similar to the connector 1, and similar components will be designated with the same reference numeral increased by 60. Therefore the connector 61 has a body 65 with a seat 66, a wedge member 70, and O-rings 78, adapted to hold tubing 15 as described above. The anti-rotation device of the connector 61 is again disposed at the top end 65u of the body 65 of the connector 61, and comprises a locking collar 82 having one lower end that is threaded on its inner surface at 82s, and an upper end that has a taper on its inner surface at 82t. The thread at 82s cooperates with an external thread on the outer surface of the upper end 65u of the body 65, and the collar 82 is thereby joined to the body. An anti-rotation slip 83 is located radially within the tapered portion of collar 82, and the outer surface of the slip has a taper that matches the inner taper at 82t on the collar 82. The slip 83 surrounds the tubular, and is collapsed to grip the tubular as the thread 82s is made up. Therefore, in this embodiment, the anti-rotation device bears on the tubular as in the first embodiment, and does not necessarily bear directly on the wedge member (but could do if desired).

The inner diameter of the anti-rotation slip 83 optionally has a gripping pattern that can optionally be hardened. In this example the gripping pattern can be parallel serrations which run axially along the component thereby restricting rotational movement of the tubular relative to the body 65 when the collar 82 is securely connected at the thread 82s. Alternative designs of gripping pattern can include diamond patterns. The gripping pattern can be cut into the inner surface of the slip 83, or can extend radially inwards from it. It can be regular or irregular. Locking bolts or other fixings could optionally be included to a) prevent the thread from backing off and b) to prevent the anti-rotation slip rotating in relation to the taper sub.

Modifications and improvements can be incorporated without departing from the scope of the invention. For example, the helix can be a right hand or a left hand helix. The connector is shown attached to the bottom of a coiled tubing string, but could also be attached to other sectors of the string, for example, in the middle or at the top of the string, or can be used to interconnect two tubing strings.

What is claimed is:

1. A connector for connecting to a tubular member, the connector having a body with a bore configured to receive the tubular member, the body having a wedge device within the bore adapted to interact with the body to grip the tubular member when the tubular member is disposed within the bore, wherein the wedge device is at least partially helical, and wherein the connector has an anti-rotation device to restrict relative rotation of the wedge device and the body when the tubular is gripped in the bore.

2. A connector according to claim 1, wherein the anti-rotation device acts directly on the wedge device.

3. A connector according to claim 2, wherein the anti-rotation device acts on the wedge device once it is in a compressed or energised configuration.

4. A connector according to claim 1 wherein the anti-rotation device acts directly on the tubular to restrict or prevent rotation of the tubular and the wedge device once the wedge device is energise by the movement of the tubular.

5. A connector according to claim 1, wherein the wedge device comprises a helix having one or more turn.

6. A connector according to claim 1, wherein the wedge device comprises a tapered surface.

7. A connector according to claim 6 wherein the tapered surface is on the outer surface of the wedge device.

8. A connector according to claim 6 wherein the inner surface of the bore of the body comprises a matching tapered surfaced which interacts with the tapered surface of the wedge device, creating a wedging effect on the tubular to restrain it within the bore of the body and to restrict or prevent axial movement of the tubular.

9. A connector according to claim 1, wherein the wedge device is adapted to move within the bore with the tubular, and to exert a compressive force on the tubular within the bore to make up the connector.

10. A connector according to claim 1, wherein the body comprises a seat which is adapted to interact with the wedge device.

11. A connector according to claim 10, wherein the seat is adapted to guide the movement of the wedge device in order to apply the compressive force against the tubular.

12. A connector according to claim 10, wherein the seat comprises a helix.

13. A connector according to claim 10, wherein the seat comprises tapered side walls which are adapted to radially compress the wedge device against the tubular member when the tubular member moves axially in one direction within the bore, and to reduce radial compression on the tubular member when the tubular member moves axially within the bore in the other direction.

14. A connector according to claim 10, wherein the seat is adapted to radially compress the wedge device when the wedge device and the seat rotate relative to one another in one direction, and to reduce radial compression on the wedge device when the two are rotated relative to one another in the opposite direction.

15. A connector according to claim 1, wherein the anti-rotation device comprises one or more fixings which are inserted through a bore in the body of the connector to act on the wedge device.

16. A connector according to claim 15, wherein the fixings comprise bolts, screws, pins, bars or circlips.

17. A connector according to claim 1, wherein the anti-rotation device comprises a collar mounted on the body.

18. A method of connecting a connector to a tubular member, the connector having a body with a bore configured to receive the tubular member, and having a partially helical wedge device within the bore, the method comprising gripping the tubular member within the bore, and locking the body and wedge device against rotation relative to one another when the tubular is gripped in the bore.

19. A method according to claim 18, wherein the wedge device is rotated relative to the body before being locked against relative rotation between the two.

20. A method according to claim 19, wherein the wedge device is pulled axially relative to the body before being locked against relative rotation between the two.
